(19) United States
(12) Patent Application Publication
(10) Pub. No.: US 2026/0280102 A1
(43) Pub. Date: Sep. 17, 2026

(54) MILLIMETER-WAVE WIRELESS COMMUNICATION DEVICE

(71) Applicant: AGC Inc., Tokyo (JP)

(72) Inventor: Daisuke YAMANAKA, Tokyo (JO)

(73) Assignee: AGC Inc., Tokyo (JP)

(21) Appl. No.: 19/675,188

(22) Filed: May 12, 2026

Related U.S. Application Data
(63) Continuation of application No. PCT/JP2024/038821, filed on Oct. 31, 2024.

(30) Foreign Application Priority Data
Nov. 13, 2023 (JP) 2023-192790

(51) Int. Cl. H01Q 1/24; H01Q 1/38

(52) U.S. Cl. CPC H01Q 1/24; H01Q 1/38

(57) ABSTRACT

A millimeter-wave wireless communication device includes a feeder circuit layer, an antenna layer, and an adhesive portion bonding the layers. The feeder circuit layer includes a first substrate made of glass or ceramic having first and second surfaces, a metal layer on the second surface with a first opening, and a first transmission line formed in the first substrate and configured as a microstrip line, strip line, coplanar line, slot line, or post-wall waveguide. The antenna layer includes a second substrate made of resin or glass having third and fourth surfaces, and an antenna element formed on the fourth surface for millimeter-wave communication. The adhesive portion adheres the metal layer on the second surface to the third surface of the second substrate. The opening and the antenna element are electrically coupled, enabling power to be fed from the transmission line through the opening to the antenna element.

### CROSS-REFERENCE TO RELATED APPLICATIONS

This application is a continuation application of International Application No. PCT/JP2024/038821 filed Oct. 31, 2024 the disclosure of which is incorporated herein by reference in its entirety. Further, this application claims priorities from Japanese Patent Application No. 2023-192790 filed Nov. 13, 2023, the disclosure of which is incorporated herein by reference in their entirety.

### TECHNICAL FIELD

This disclosure relates to a millimeter-wave wireless communication device.

### BACKGROUND ART

Conventionally, there have been technologies for fabricating antennas for the millimeter-wave band by using physical vapor deposition (PVD) and plating to form a copper layer on both sides of each a plurality of glass wafers and then performing thermal compression bonding (TCB) to bond the plural glass wafers together (e.g., see “A W-Band Corporate-Fed Hollow-Waveguide Slot Array Antenna by Glass Micromachining.” Yaxiang Wu, Tian Yu, Miao Zhang, Daquan Yu, Jiro Hirokawa, Qing Huo Liu. Proceedings of ISAP 2020, Osaka, Japan. (non-patent document 1)).

In this connection, millimeter-wave antennas fabricated by bonding together a plurality of glass wafers as described above are not suited for mass production because they are difficult to fabricate.

### SUMMARY

Thus, it is an object to provide a millimeter-wave wireless communication device that can be easily fabricated.

A millimeter-wave wireless communication device of an embodiment of this disclosure includes: a first feeder circuit layer having a first substrate that has a first surface and a second surface and is made of glass or ceramic, a metal layer that is provided on the second surface and has a first opening, and a first transmission line that is configured by a microstrip line, a strip line, a coplanar line, a slot line, or a post-wall waveguide formed in the first substrate; an antenna layer having a second substrate that has a third surface and a fourth surface and is made of resin or glass and an antenna element that is formed on the fourth surface and communicates in the millimeter-wave band; and an adhesive portion that adheres the metal layer provided on the second surface of the first substrate of the first feeder circuit layer and the third surface of the second substrate of the antenna layer to each other, wherein the first opening and the antenna element are electrically coupled, and power can be fed from the first transmission line through the first opening to the antenna element.

There can be provided millimeter-wave wireless communication device that can be easily fabricated.

### BRIEF DESCRIPTION OF DRAWINGS

FIG. 1 is a drawing showing an example of a millimeter-wave wireless communication device 100 of an embodiment in an exploded state.

FIG. 2 is a drawing showing an example of the cross-sectional configuration of the millimeter-wave wireless communication device 100.

FIG. 3A is a drawing showing an example of an actual millimeter-wave wireless communication device 100.

FIG. 3B is an enlarged view of the millimeter-wave wireless communication device 100 shown in FIG. 3A.

FIG. 4A is a drawing showing an example of the frequency characteristic of the S11 parameter.

FIG. 4B is a drawing showing an example of the frequency characteristic at maximum gain.

FIG. 4C is a drawing showing an example of the frequency characteristics of efficiency and antenna efficiency.

FIG. 5A is a drawing showing an example of radiation characteristics.

FIG. 5B is a drawing showing an example of radiation characteristics.

FIG. 6 is a drawing showing an example of the configuration of cavities 110B provided in a feeder circuit layer 110.

FIG. 7 is a drawing showing an example of the cross-sectional configuration of a millimeter-wave wireless communication device 100M1 of a first example modification of the embodiment.

FIG. 8 is a drawing showing an example of a millimeter-wave wireless communication device 100M2 of a second example modification of the embodiment in an exploded state.

FIG. 9A is a drawing showing an example of the cross-sectional configuration of the millimeter-wave wireless communication device 100M2 of the second example modification. FIG. 9B is a drawing showing an example of the cross-sectional configuration of the millimeter-wave wireless communication device 100M2 of another aspect of the second example modification.

FIG. 10 is a drawing showing an example of the cross-sectional configuration of a millimeter-wave wireless communication device 100M3 of a third example modification of the embodiment.

### DETAILED DESCRIPTION

An embodiment to which the millimeter-wave wireless communication device of this disclosure is applied will be described below. In what follows, identical elements are assigned identical reference signs and redundant description may be omitted.

In what follows, description will be given with a defined XYZ coordinate system. The direction parallel to the X-axis (X-direction), the direction parallel to the Y-axis (Y-direction), and the direction parallel to the Z-axis (Z-direction) are mutually orthogonal. Furthermore, for convenience of description, the −Z-direction may be referred to as the lower side or under and the +Z-direction as the upper side or above, but this is not intended to express a universal vertical relationship. Furthermore, “as viewed in a plan view” refers to a view in the XY plane.

Furthermore, in what follows, the length, width, and thickness of each part may be exaggerated to facilitate understanding of configurations. Furthermore, terms such as parallel, perpendicular, orthogonal, horizontal, vertical, and above/under should be understood as allowing for deviations of an extent that do not impair the advantageous effects of the embodiment.

Furthermore, in the following description, “radio wave” refers to a type of electromagnetic wave, and generally electromagnetic waves equal to or lower than 3 THz are called radio waves. In what follows, electromagnetic waves radiated from an outdoor base station or relay station will be called “radio waves,” and electromagnetic waves in general will be called “electromagnetic waves.” Furthermore, in what follows, “millimeter waves” or “millimeter-wave band” will refer to a 30 GHz to 300 GHz frequency band.

It is preferred that the frequency (communication frequency) of radio waves transmitted or received by the millimeter-wave wireless communication device of the embodiment be equal to or higher than 30 GHz and equal to or lower than 300 GHz as an example. This frequency band is an even higher frequency band than the 1 GHz to 30 GHZ frequency band, which includes the fifth generation mobile communication system (5G) millimeter-wave band and Sub-6, and may be employed in fixed stations, integrated access and backhaul (IAB), wireless backhaul/wireless fronthaul, fixed wireless access (FWA), and subsequent generations of communication systems after the fifth generation mobile communication system (5G).

Furthermore, the radio waves transmitted or received by the millimeter-wave wireless communication device of the embodiment may be the fifth generation mobile communication system (5G) millimeter-wave band and Sub-6, Long-Term Evolution (LTE), LTE-Advanced (LTE-A), or Ultra Mobile Broadband (UMB). Furthermore, the radio waves transmitted or received by the millimeter-wave wireless communication device of the embodiment may be IEEE 802.11 (Wi-Fi (registered trademark)), IEEE 802.16 (WiMAX (registered trademark)), IEEE 802.20, Ultra-Wideband (UMB), Bluetooth (registered trademark), or Low-Power Wide-Area (LPWA). In what follows, unless otherwise specified, description will be given using radio waves equal to or higher than 30 GHz and equal to or lower than 300 GHz as an example.

### Embodiment

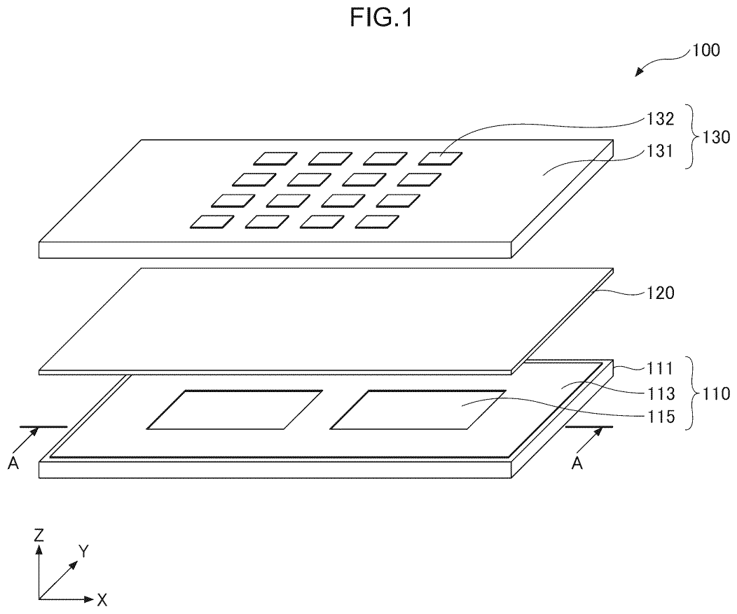

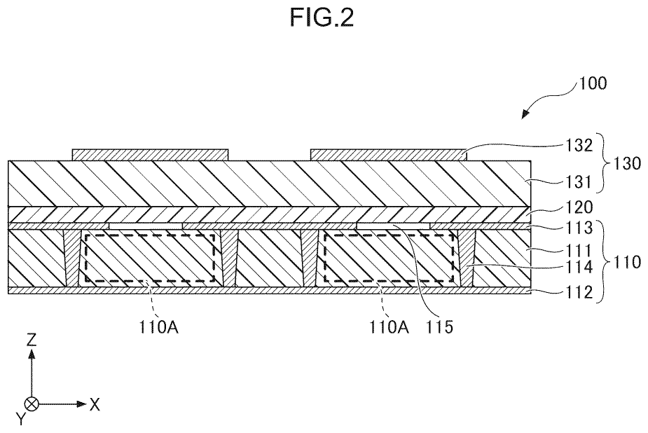

FIG. 1 is a drawing showing an example of a millimeter-wave wireless communication device 100 of the embodiment in an exploded state. FIG. 2 is a drawing showing an example of the cross-sectional configuration of the millimeter-wave wireless communication device 100. The cross-section shown in FIG. 2 is a cross-section corresponding to a cross-section viewed from arrows A-A in FIG. 1 in a state in which the millimeter-wave wireless communication device 100 is assembled. FIG. 2 is an enlarged view of a portion of the entire millimeter-wave wireless communication device 100 corresponding to two antenna elements 132.

### Millimeter-Wave Wireless Communication Device 100

The millimeter-wave wireless communication device 100 includes a feeder circuit layer 110, an adhesive layer 120, and an antenna layer 130. The feeder circuit layer 110 is an example of a first feeder circuit layer. The adhesive layer 120 is an example of an adhesive portion. It will be noted that the millimeter-wave wireless communication device 100 may be even larger in the X-direction and the Y-direction.

The millimeter-wave wireless communication device 100 is as an example a device capable of beamforming using a plurality of antenna elements 132 of the antenna layer 130 as a phased array antenna by adjusting, with a phase shifter not shown in the drawings, the phase of radio waves in the millimeter-wave band transmitted and received by the plural antenna elements 132. The millimeter-wave band is a band included in 30 GHz to 300 GHz as an example.

Here, prior to describing the detailed configuration of the millimeter-wave wireless communication device 100, the background of problems that occur when wireless communication is performed using radio waves in the millimeter-wave band included in the 30 GHz to 300 GHz frequency band will be described. Here, description will be given using a millimeter-wave wireless communication device not included in the embodiment. The millimeter-wave wireless communication device not included in the embodiment has a phased array antenna configured by a plurality of antenna elements.

### Background when Wireless Communication is Conducted Using Radio Waves in the Millimeter-Wave Band

When wireless communication is performed using radio waves in the millimeter-wave band included in the 30 GHz to 300 GHz frequency band, signal loss in radio frequency (RF) circuits such as transmission lines connected to the antenna elements becomes extremely large, so it is desirable to dispose the antenna elements and the RF circuits extremely close to each other and integrate them.

In a phased array antenna, it is necessary to integrate the RF circuits and the plural antenna elements to improve the performance of the millimeter-wave wireless communication device, but signal loss occurs in the connected portions of the antenna elements and the RF circuits, resulting in reduced communication performance. Furthermore, although integrating the RF circuits and the antenna elements is expected to improve communication performance, the difficulty of implementation dramatically increases because particularly in high frequency bands of 100 GHz and higher the free space wavelength is 3 mm or shorter.

In a phased array antenna, the connection structure of the antenna layer having the plural antenna elements and the feeder circuit layer that feeds power to the plural antenna elements is an important factor that directly affects communication performance. Conventionally, connection structures using vias and through holes have come to be used to transmit signals in frequency bands lower than the millimeter-wave band, but particularly in high frequency bands equal to or higher than 100 GHz, parasitic inductance and parasitic capacitance make application difficult.

In connection structures using vias or through holes, metal cylindrical parts that penetrate the antenna layer and the feeder circuit layer are used, so parasitic inductance and parasitic capacitance occur between the antenna layer and the feeder circuit layer. These parasitic components have a significant effect on impedance matching between the antenna layer and the feeder circuit layer and may reduce communication performance. Such problems become more pronounced the higher the frequency is.

To address such problems, an electromagnetic coupling connection structure using slots has been proposed as a connection structure for the antenna layer and the feeder circuit layer. The connection structure using slots utilizes electromagnetic coupling without using vias or through holes, so even when handling radio waves in the millimeter-wave band, the desired impedance matching can be achieved by the shapes of the slots and the antenna elements.

In this connection, in a connection structure using slots, reflection occurs due to the relative permittivities of the feeder circuit layer and the antenna layer being significantly different, and communication performance may be reduced by reflection loss. Reflection loss occurs due to the significant difference in the relative permittivities of the feeder circuit layer and the antenna layer, and some of the power input to the antenna elements ends up being reflected to the feeder circuit layer, so problems such as a reduction in the efficiency and a reduction in the directivity of the antenna elements occur.

### Overview of Millimeter-Wave Wireless Communication Device 100

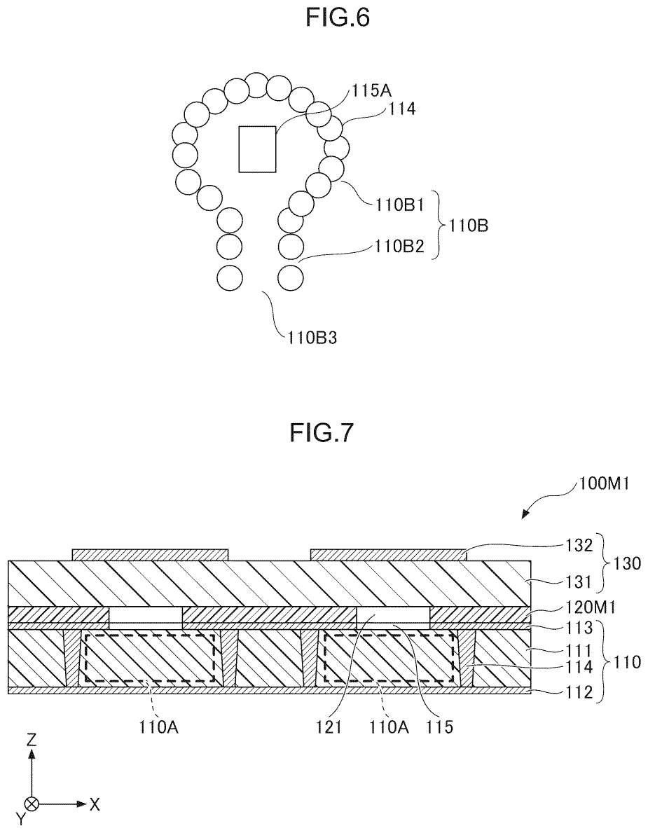

From the standpoint of addressing the problem of impedance matching between the antenna layer and the feeder circuit layer described in the background above, the millimeter-wave wireless communication device 100 of the embodiment employs as an example a configuration where power is fed to the antenna elements 132 of the antenna layer 130 using slots 115 in the feeder circuit layer 110. It will be noted that impedance matching can also be realized with a configuration other than the slots 115, and such a configuration will be described below using FIG. 6.

Furthermore, from the standpoint of addressing the problem of reflection loss described in the background above, the millimeter-wave wireless communication device 100 of the embodiment employs a structure where the feeder circuit layer 110 and the antenna layer 130 are bonded together with an adhesive layer 120 in order to easily realize a connection structure for the feeder circuit layer 110 and the antenna layer 130 in which the difference in relative permittivities is small. The components of the millimeter-wave wireless communication device 100 will now be described below.

### Feeder Circuit Layer 110

The feeder circuit layer 110 has a substrate 111, a metal layer 112, a metal layer 113, vias 114, and slots 115. Furthermore, the feeder circuit layer 110 has transmission lines that transmit radio waves in the millimeter-wave band. The transmission lines that the feeder circuit layer 110 has are an example of first transmission lines.

The substrate 111 is an example of a first substrate. The lower surface of the substrate 111 is an example of a first surface, and the upper surface of the substrate 111 is an example of a second surface. The slots 115 are an example of first openings. The metal layer 113 is an example of a metal layer that is provided on the second surface and has a first opening.

Here, an aspect in which the transmission lines that the feeder circuit layer 110 has are post-wall waveguides 110A as an example will be described. The post-wall waveguides 110A are configured by the substrate 111, the metal layer 112, the metal layer 113, and the vias 114. A plurality of the vias 114 are arrayed in the Y-direction in the positions of the four vias 114 shown in FIG. 2, and the post-wall waveguides 110A are provided in portions surrounded by the metal layer 112, the metal layer 113, and the vias 114. FIG. 2 shows a cross-section of two post-wall waveguides 110A. Although the post-wall waveguides 110A extend in the Y-direction as an example in the portion of the cross-section of the millimeter-wave wireless communication device 100 shown in FIG. 2, they may have portions that extend in the X-direction.

It will be noted that the transmission lines that the feeder circuit layer 110 has are not limited to the post-wall waveguides 110A and may be microstrip lines, strip lines, coplanar lines, or slot lines.

### Substrate 111

The substrate 111 is provided with the transmission lines of the feeder circuit layer 110, so it is fabricated using a material with which there is a low loss of radio waves in the millimeter-wave band, such as glass or ceramic. Examples of materials with which there a low loss of radio waves in the millimeter-wave band in this way include as an example quartz glass and low-temperature co-fired ceramics (LTCC). The relative permittivity of the substrate 111 is higher than the relative permittivity of a substrate 131 of the antenna layer 130. Furthermore, the coefficient of linear expansion of the substrate 111 is lower than the coefficient of linear expansion of the substrate 131. Details about the relative permittivities and the coefficients of linear expansion of the substrates 111 and 131 will be described below.

### Metal Layer 112

The metal layer 112 is provided on the lower surface of the substrate 111 and is held at ground potential (reference potential). The metal layer 112 is copper foil or aluminum foil as an example and is formed by deposition or the like on the lower surface of the substrate 111.

### Metal Layer 113

The metal layer 113 is provided on the upper surface of substrate 111 and is held at ground potential (reference potential). In the metal layer 113 are formed the slots 115. The metal layer 113 is copper foil or aluminum foil as an example and is formed by deposition or the like on the upper surface of the substrate 111. The metal layer 113 is formed of the same metal as the metal layer 112 as an example.

### Vias 114

The vias 114 are formed inside through holes that penetrate the substrate 111 in the Z-direction. The vias 114 can be formed of copper or aluminum as an example and are formed of the same metal as the metal layers 112 and 113 as an example. The vias 114 can as an example be formed by using laser machining or the like to fabricate through holes that penetrate the substrate 111 in the Z-direction prior to forming the metal layers 112 and 113 on the substrate 111 and then filling the insides of the through holes with metal by plating or the like. Lower ends and upper ends of the vias 114 are connected to the metal layers 112 and 113, respectively.

Since the vias 114 configure side walls of the post-wall waveguides 110A as an example, they are formed on both sides of the post-wall waveguides 110A at appropriate intervals along the extension direction of the post-wall waveguides 110A so that leakage of millimeter waves does not occur. In the cross-section shown in FIG. 2, one post-wall waveguide 110A is provided between the first and second vias 114 from the-X-direction side, and another post-wall waveguide 110A is provided between the third and fourth vias 114 from the-X-direction side.

### Slots 115

The slots 115 are provided in the metal layer 113. One slot 115 is provided in correspondence to each antenna element 132 of the antenna layer 130. It will be noted that since the antenna layer 130 need only have at least one antenna element 132, the feeder circuit layer 110 may have one slot 115 when the number of antenna elements 132 is one.

The shape of the slots 115 as viewed in a plan view may as an example be rectangular, circular, elliptical, or cross-shaped. The slots 115 are provided in positions overlapping each of the antenna elements 132 of the antenna layer 130 as viewed in a plan view. The slots 115 may be positioned inside the outer edges of the antenna elements 132 as viewed in a plan view, or at least parts of the slot 115 may be positioned inside the outer edges of the antenna elements 132. Here, as an example, the shape of the slots 115 as viewed in a plan view is rectangular, and their longitudinal direction extends in the Y-direction.

The slots 115 are electromagnetically coupled to the antenna elements 132. When the antenna elements 132 transmit radio waves, the slots 115 transmit in the +Z-direction the radio waves propagating through the post-wall waveguides 110A and function as slot antennas to feed power to the antenna elements 132. Furthermore, when the antenna elements 132 receive radio waves, the slots 115 transmit the radio waves fed from the antenna elements 132 to the insides of the post-wall waveguides 110A.

It will be noted that when microstrip lines, strip lines, coplanar lines, or slot lines are used as the transmission lines instead of the post-wall waveguides 110A, the following is done.

In the case of microstrip lines, as an example, the metal layer 113 is held at ground potential and wires for signal transmission are provided on the metal layer 112 with the tips of the wires overlapping the slots 115 as viewed in a plan view. The tips of the wires and the slots 115 are electromagnetically coupled so that power can be fed from the wires to the slots 115.

In the case of strip lines, the metal layers 112 and 113 are held at ground potential and wires for signal transmission are provided between the metal layers 112 and 113 with the tips of the wires overlapping the slots 115 as viewed in a plan view. The tips of the wires and the slots 115 are electromagnetically coupled so that power can be fed from the wires to the slots 115.

In the case of coplanar lines, coplanar lines are provided on the metal layer 112 so that the tips of the wires for signal transmission of the coplanar lines overlap the slots 115 as viewed in a plan view. The tips of the wires and the slots 115 are electromagnetically coupled to that power can be fed from the wires to the slots 115.

In the case of slot lines, slots are provided in the metal layer 112 so that the distal ends of the slots overlap the slots 115 as viewed in a plan view. The distal ends of the slots and the slots 115 are electromagnetically coupled so that power can be fed from the wires to the slots 115.

### Adhesive Layer 120

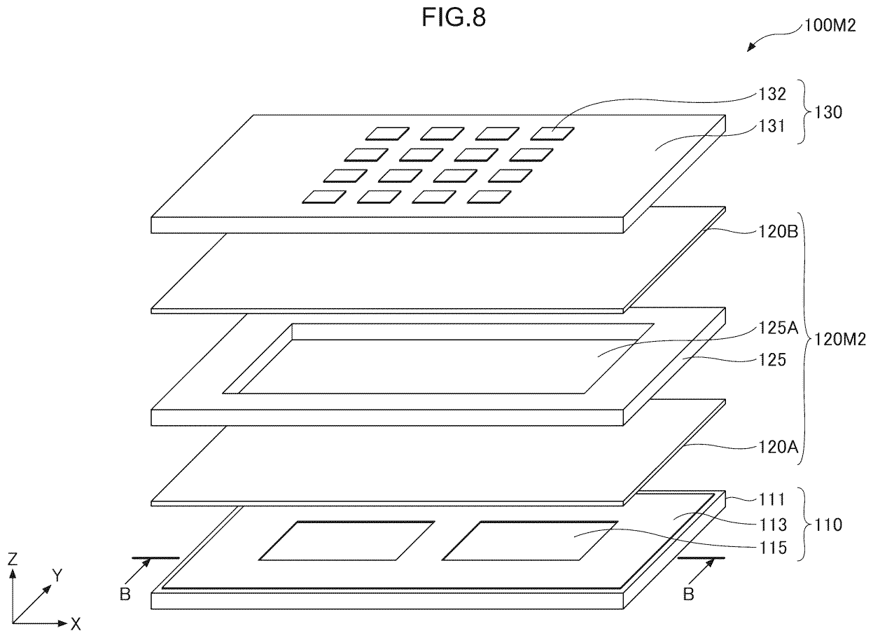

The adhesive layer 120 adheres the feeder circuit layer 110 and the antenna layer 130 to each other. Although a resin adhesive layer or a conductive adhesive layer can be used as the adhesive layer 120, here, as an example, an aspect where the adhesive layer 120 is configured by a resin adhesive layer will be described. It will be noted that an adhesive layer 120M1 configured by a conductive adhesive layer will be described below using FIG. 7.

The relative permittivity of the adhesive layer 120 is equal to or lower than the relative permittivity of the substrate 111. It is preferred that the relative permittivity of the adhesive layer 120 be higher than the relative permittivity of the substrate 131 and lower than the relative permittivity of the substrate 111. It will be noted that details about the relative permittivity of the adhesive layer 120 will be described below.

As the resin adhesive layer used as the adhesive layer 120, as an example, a thermoplastic resin, a thermosetting resin, a bonding sheet not including a conductor, a prepreg, an adhesive resin including a resin film, or a liquid adhesive can be used.

The adhesive layer 120 adheres the feeder circuit layer 110 and the antenna layer 130, which are separately formed, to each other. The millimeter-wave wireless communication device 100 can be fabricated by simply bonding together the feeder circuit layer 110 and the antenna layer 130 with the adhesive layer 120. For this reason, it is not necessary to perform the work of forming copper layers by physical vapor deposition (PVD) and plating on both sides of each of a plurality of glass wafers and then bonding the plural glass wafers together by performing solid-phase diffusion bonding such as thermal compression bonding (TCB) as has conventionally been the case.

### Antenna Layer 130

The antenna layer 130 has a substrate 131 and the antenna elements 132. The substrate 131 is an example of a second substrate. The lower surface of the substrate 131 is an example of a third surface, the upper surface of the substrate 131 is an example of a fourth surface, and, as shown in FIG. 1, a plurality of the antenna elements 132 as an example are provided.

### Substrate 131

The substrate 131 is as an example a substrate with the same size and shape as the substrate 111 of the feeder circuit layer 110 as viewed in a plan view. However, the substrate 131 need not have the same size and shape as the substrate 111 as viewed in a plan view.

Furthermore, the substrate 131 has as an example a lower permittivity than the relative permittivity of the substrate 111 of the feeder circuit layer 110 and is a substrate made of resin or glass in which the loss of radio waves in the millimeter-wave band is low. As the resin material, a thermoplastic resin or a thermosetting resin having a low relative permittivity and in which the loss of radio waves in the millimeter-wave band is low can be used.

Furthermore, as the glass material, quartz glass or porous quartz glass having a low relative permittivity and in which the loss of radio waves in the millimeter-wave band is low can be used. Furthermore, a composite substrate in which a plurality of resin materials are layered or mixed or a composite substrate in which a resin material and a glass material are layered or mixed can also be used. The relative permittivity in this case is the effective relative permittivity of the substrate. Furthermore, the coefficient of linear expansion of the substrate 131 is as an example higher than the coefficient of linear expansion of the substrate 111. It will be noted that details about the relative permittivities and coefficients of linear expansion of the substrates 131 and 111 will be described below.

### Antenna Elements 132

The antenna elements 132 are as an example radiating elements configured by metal foils with a rectangular shape as viewed in a plan view. As an example, a plurality of the antenna elements 132 are arrayed in an array on the upper surface of the substrate 131.

Although FIG. 1 shows as an example a configuration where sixteen antenna elements 132 are arrayed in a 4×4 array in the X-direction and the Y-direction, the millimeter-wave wireless communication device 100 need only include at least one antenna element 132.

The antenna elements 132 are configured by copper foil or aluminum foil as an example and are formed on the upper surface of the substrate 131 by deposition or the like.

As an example, the plural the antenna elements 132 may be used as a phased array antenna, and adjusting the amplitude and phase of the radio waves transmitted and received by the plural antenna elements 132 enables beam formation and beam scanning.

### Relative Permittivities and Coefficients of Linear Expansion of Substrates 111 and 131 and Adhesive Layer 120

Here, the relationship between the relative permittivities of the substrate 111, the adhesive layer 120, and the substrate 131 and the relationship between the coefficients of linear expansion of the substrates 111 and 131 will be described.

One of the development goals of the millimeter-wave wireless communication device 100 is to reduce the loss of radio waves in the millimeter-wave band to enable it to transmit and receive millimeter waves in a high frequency band equal to or higher than 100 GHz within the millimeter-wave band of 30 GHz to 300 GHz as an example.

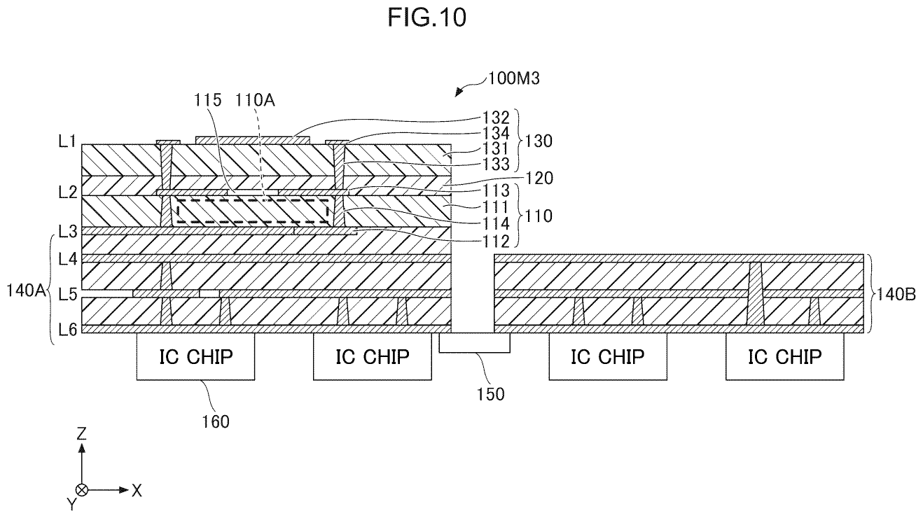

In millimeter-wave transceivers in a high frequency band equal to or higher than 100 GHz, the main issues are IC chip size and heat dissipation from power amplifiers, so a segmented phased array antenna design is used. For example, in the transmitter, a plurality of antenna elements are fed power by an RF chain configured by a single phase shifter and a power amplifier, and in the receiver, a plurality of antenna elements are connected to an RF chain configured by a single LNA and a phase shifter. The circuit for such a transmitter and receiver has as an example the configuration of an IC chip 160 mounted on a feeder circuit layer 140A described below using FIG. 10. In such a segmented phased array antenna, transmission signals are upconverted to millimeter waves in a high frequency band of 100 GHz or more and then routed from the feeder circuit layer to each antenna element. Reception signals are downconverted by the reverse operation.

For this reason, from the standpoint of the operating bandwidth, it is desirable to adopt a power feed method using a parallel power supply system. In a parallel power supply system, it is necessary to form a feeder circuit layer that can supply signals that are in phase to all of the transmit RF chain, the receive RF chain, and the antenna elements, so the length of the entire power feed path becomes longer. For these reasons, the large loss caused by the feeder circuit layer becomes an issue.

From this standpoint, in order to reduce the loss of radio waves in the millimeter-wave band in the feeder circuit layer 110, the substrate 111 is fabricated using a material with which the loss of radio waves in the millimeter-wave band is low. Examples of such materials for the substrate 111 include glass and ceramic, and particularly quartz glass is preferred.

Since a material with a high relative permittivity such as quartz glass as an example is used for the substrate 111 of the feeder circuit layer 110, the wavelength shortening effect is large, and in FIG. 2 the width of the post-wall waveguides 110A in the X-direction can be reduced a certain extent.

In this connection, when a plurality of antenna elements 132 are arrayed, the pitch between adjacent antenna elements 132 is about 0.5λ to λ when λ is the free space wavelength at the frequency of the radio waves (operating frequency) that the millimeter-wave wireless communication device 100 uses for communication. The pitch is the distance in the X-direction or the Y-direction between the centers of adjacent antenna elements 132.

Furthermore, the length of each antenna element 132 in the X-direction and the Y-direction is about ½ of the electrical length λe of the free space wavelength λ at the operating frequency. The electrical length λe is shorter than the free space wavelength λ due to the shortening effect caused by the relative permittivity of the substrate 131. Under these constraints, it is necessary to provide gaps between adjacent antenna elements 132.

When a plurality of antenna elements 132 are disposed with such a pitch and gaps, it is necessary to dispose the post-wall waveguides 110A in the feeder circuit layer 110 to match the antenna elements 132. As an example, in the cross-section shown in FIG. 2, two post-wall waveguides 110A are disposed matching the pitch of two adjacent antenna elements 132.

Under the above constraints, in order to reduce reflection loss and ensure the radiation efficiency and bandwidth of the antenna elements, the relative permittivity of the substrate 131 is set equal to or lower than the relative permittivity of the substrate 111. Satisfying this relationship between the relative permittivities makes it easier to reduce reflection loss and realize transmission of radio waves in the millimeter-wave band with low loss.

Consequently, the relative permittivity of the substrate 131 is equal to or lower than the relative permittivity of the substrate 111. Using this relationship between the relative permittivities can effectively reduce reflection loss between the slots 115 and the antenna elements 132.

Furthermore, when & represents the relative permittivity of the substrate 111, it is more preferred that the relative permittivity ε₂ of the substrate 131 be equal to or higher than √ε₁ and equal to or lower than ε₁. This is because when the relative permittivity ε₂ of the substrate 131 is a value within this range, reflection loss between the slots 115 and the antenna elements 132 can be effectively reduced.

Furthermore, it is even more preferred that the relative permittivity ε₂ of the substrate 131 be lower than the relative permittivity ε₁ of the substrate 111. This is because reflection loss between the slots 115 and the antenna elements 132 can be even more effectively reduced.

Furthermore, as regards the adhesive layer 120, it is preferred that the relative permittivity ε₃ of the adhesive layer 120 be equal to or higher than √ε₁ and equal to or lower than ε₁. This is because when the relative permittivity ε₃ of the adhesive layer 120 positioned between the feeder circuit layer 110 and the antenna layer 130 is a value within this range, reflection loss between the slots 115 and the antenna elements 132 can be effectively reduced.

Furthermore, it is more preferred that the relative permittivity ε₃ of the adhesive layer 120 be higher than the relative permittivity ε₂ of the substrate 131 and lower than the relative permittivity ε₁ of the substrate 111. This is because when the relative permittivity ε₃ of the adhesive layer 120 is a value between the relative permittivity ε₂ of the substrate 131 and the relative permittivity ε₁ of the substrate 111, the relationship between the relative permittivities of the feeder circuit layer 110, the adhesive layer 120, and the antenna layer 130 changes stepwise in a stepped manner, so that the difference between the relative permittivities of the feeder circuit layer 110 and the antenna layer 130 can be mitigated, and reflection loss between the slots 115 and the antenna elements 132 can be more effectively reduced.

Furthermore, it is preferred that the coefficient of linear expansion of the substrate 131 be higher than the coefficient of linear expansion of the substrate 111. In other words, it is preferred that the coefficient of linear expansion of the substrate 111 be equal to or lower than the coefficient of linear expansion of the substrate 131. For example, when a plurality of antenna elements 132 are used as a phased array antenna, it is conceivable as an example to mount an integrated circuit (IC) chip with a built-in phase shifter and amplifier on a substrate or the like provided under the feeder circuit layer 110. Since the IC chip gives off a lot of heat, the substrate 111 of the feeder circuit layer 110 and the substrate 131 of the antenna layer 130 positioned on the upper side of the feeder circuit layer 110 are heated, and the millimeter-wave wireless communication device 100 may become warped due to the difference between the coefficients of linear expansion of the substrate on which the IC chip is mounted, the substrate 111, and the substrate 131. In order to inhibit such warping associated with heat release, it is preferred that the coefficient of linear expansion of the substrate 111 be low in order to inhibit warping of the substrate on which the IC chip is mounted. From this standpoint, it is preferred that the coefficient of linear expansion of the substrate 111 be equal to or lower than the coefficient of linear expansion of the substrate 131. In other words, it is preferred that the coefficient of linear expansion of the substrate 131 be higher than the coefficient of linear expansion of the substrate 111.

### Configuration of Actual Millimeter-wave Wireless Communication Device 100

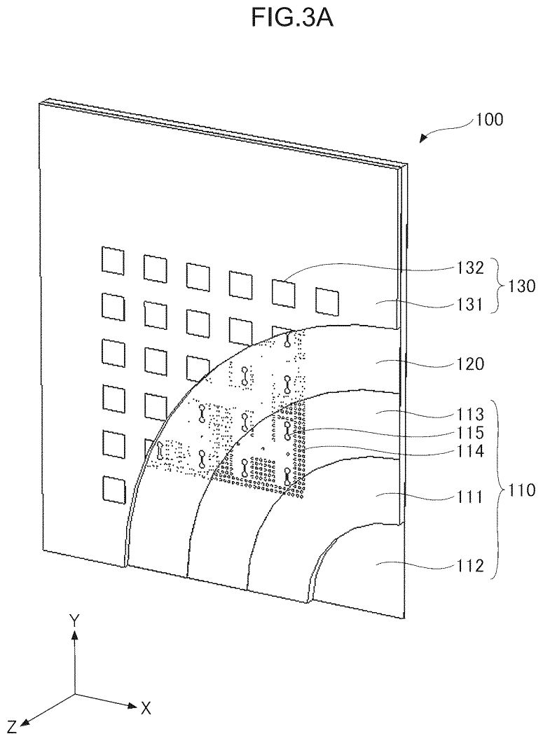

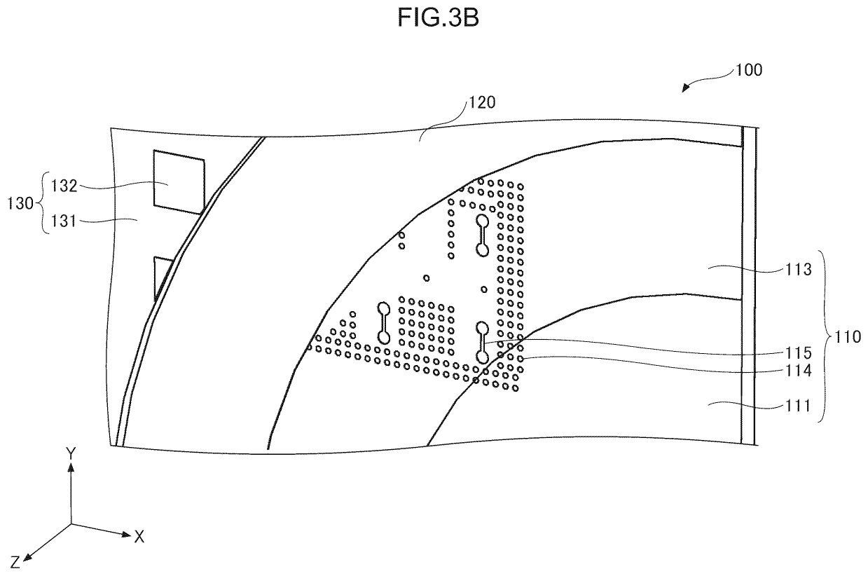

FIG. 3A is a drawing showing an example of an actual millimeter-wave wireless communication device 100. FIG. 3A shows part of the actual millimeter-wave wireless communication device 100 in a partial cross-section. FIG. 3B is an enlarged view of the millimeter-wave wireless communication device 100 shown in FIG. 3A.

Here, the arrangement of the slots 115 and the vias 114 will be described using FIG. 3A and FIG. 3B. In the parts where the antenna layer 130 and the adhesive layer 120 are omitted in the partial cross-sections of FIG. 3A and FIG. 3B, one can see the slots 115 and the vias 114. The slots 115 each have a longitudinal direction extending in the Y-direction as an example, and both ends of each of the slots 15 in the longitudinal direction widen into circles.

The vias 114 are difficult to see in FIG. 3A, but as shown in FIG. 3B, they are arranged so that the upper ends of the numerous vias 114 surround the plural slots 115. The post-wall waveguides 110A (see FIG. 2) are formed by the numerous vias 114 surrounding the slots 115.

In this way, in the actual millimeter-wave wireless communication device 100, the post-wall waveguides 110A are formed by the numerous vias 114. Since the vias 114 are side walls of the post-wall waveguide 110A, the vias 114 do not transmit signals.

### Simulation Results

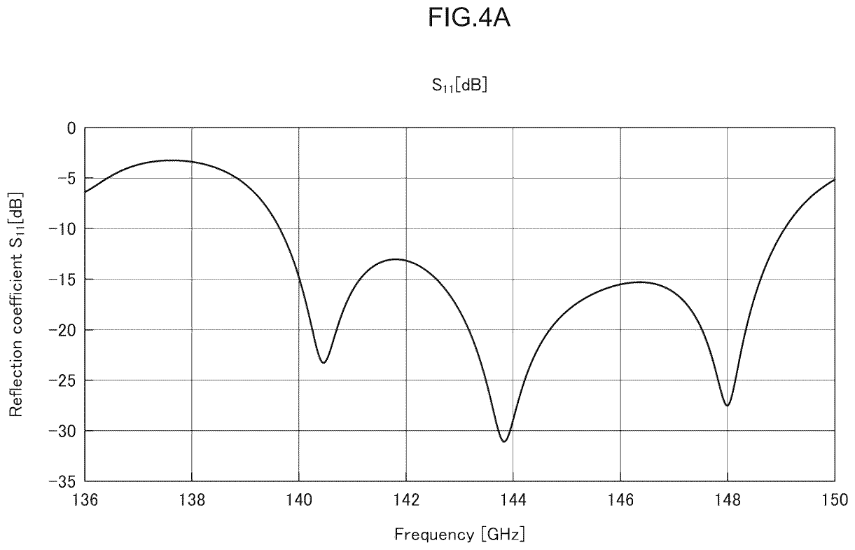

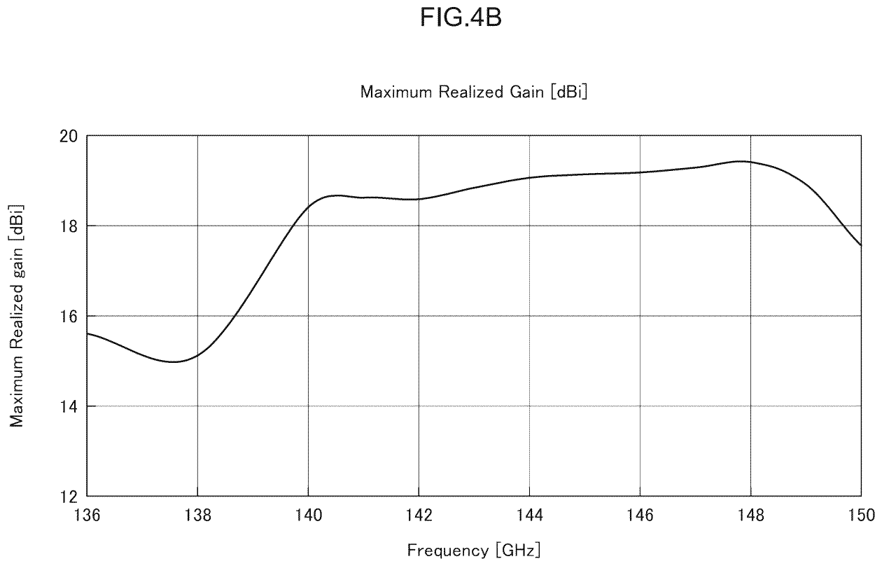

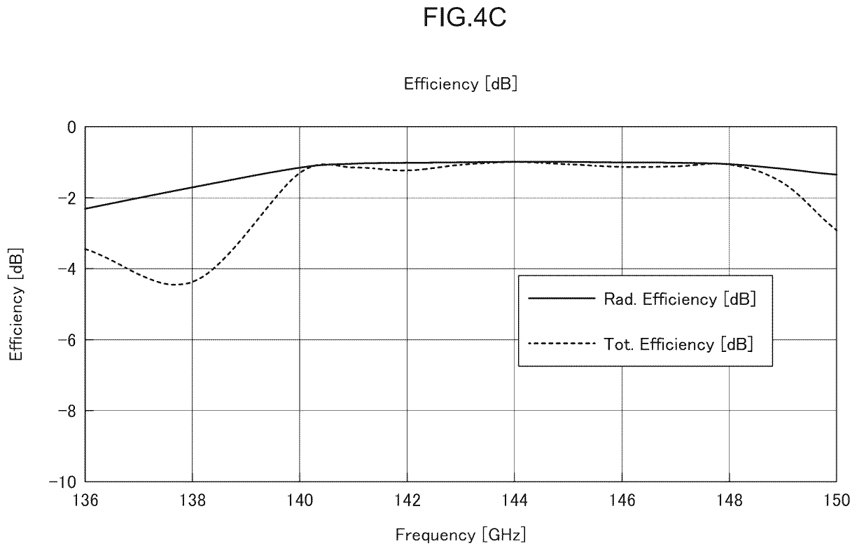

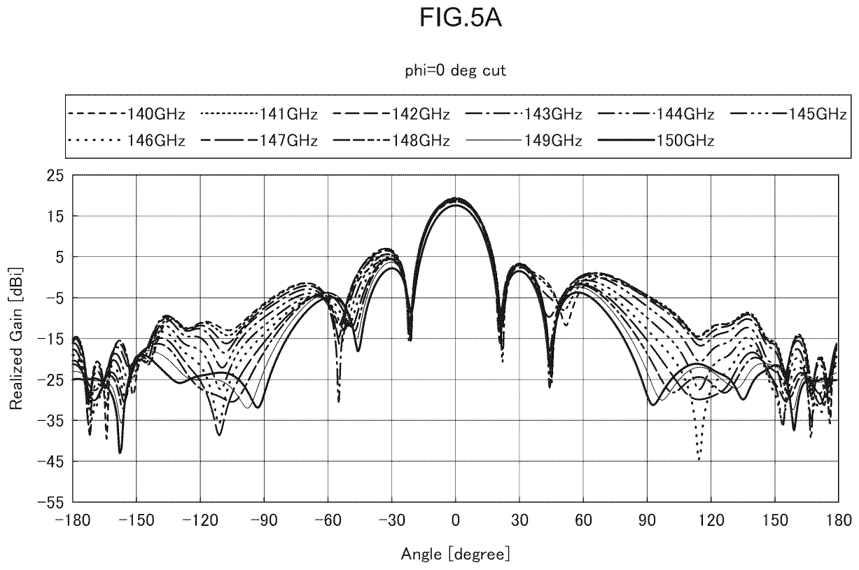

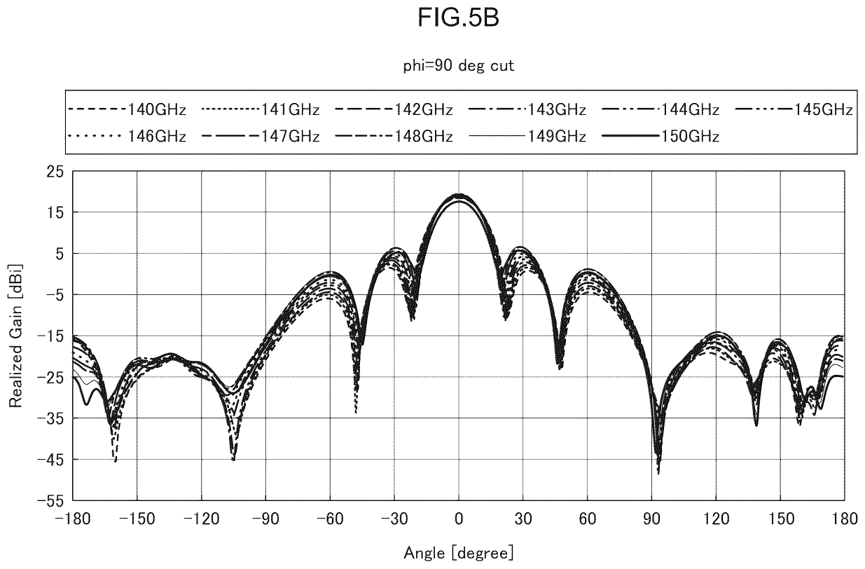

An electromagnetic field simulation was performed in regard to the millimeter-wave wireless communication device 100 having the cross-sectional configuration shown in FIG. 2. FIG. 4A is a drawing showing an example of the frequency characteristic of the S11 parameter (dB). FIG. 4B is a drawing showing an example of the frequency characteristic at maximum gain (dBi). FIG. 4C is a drawing showing an example of the frequency characteristics of efficiency (dB) and antenna efficiency (dB). FIG. 5A and FIG. 5B are drawings showing examples of radiation characteristics.

### Frequency Characteristic of S11 Parameter (FIG. 4A)

The S11 parameter shown in FIG. 4A represents a reflection coefficient representing the ratio of radio waves input to the post-wall waveguides 110A that return to the post-wall waveguides 110A. Radio waves that are not reflected are radiated from the post-wall waveguides 110A and through the slots 115 from the antenna elements 132.

As an example, when the S11 parameter was evaluated at the level of −10 dB, it was equal to or lower than-10 dB in the band from about 140 GHz to about 149 GHZ.

### Frequency Characteristic at Maximum Gain (dBi) (FIG. 4B)

For the frequency characteristic at maximum gain (dBi) shown in FIG. 4B, good values of about 19 (dBi) to about 19.5 (dBi) were obtained in the band of about 140 GHz to about 149 GHZ.

### Frequency Characteristic of Efficiency (dB) (FIG. 4C)

In FIG. 4C, the efficiency (Rad. Efficiency) (dB) is indicated by a solid line and the antenna efficiency (Total Efficiency) (dB) is indicated by a dashed line. As shown in FIG. 4C, good values of −1 (dB) were obtained for both the maximum efficiency and the radiation efficiency in the band of about 140 GHz to about 149 GHZ.

### Radiation Characteristics (FIG. 5A)

FIG. 5A shows radiation characteristics in the polar angle (zenith angle) direction in the XZ plane (phi =0 deg.). The origin of the XYZ coordinates was set at the center of the upper surface of one antenna element 132, and radiation characteristics in the polar angle direction in the XZ plane were calculated for radio wave frequencies from 140 GHz to 150 GHz in 1 GHz increments. In FIG. 5A, the radiation characteristics are represented by realized gain (dB). The 0-degree direction is the +Z-direction, the −180-degree direction is the −X-direction, and the +180 degree direction is the +X-direction.

As shown in FIG. 5A, for all frequencies from 140 GHz to 150 GHz, the radiation characteristics in the polar angle direction in the XZ plane had the greatest radiation intensity at the center (0 degrees) and were substantially symmetrical from −180 degrees to +180 degrees relative to the center (0 degrees).

### Radiation Characteristics (FIG. 5B)

FIG. 5B shows the radiation characteristics in the polar angle (zenith angle) direction on the YZ plane (phi =90 deg.). The origin of the XYZ coordinates was set in the center of the upper surface of one antenna element 132, and radiation characteristics in the polar angle direction in the YZ plane were calculated for radio wave frequencies from 140 GHz to 150 GHz in 1 GHz increments. In FIG. 5B, the radiation characteristics are represented by realized gain (dB). The 0-degree direction is the +Z-direction, the −180-degree direction is the −Y-direction, and the +180 degree direction is the +Y-direction.

As shown in FIG. 5B, for all frequencies from 140 GHz to 150 GHz, the radiation characteristics in the polar angle direction in the YZ plane had the greatest radiation intensity at the center (0 degrees) and were substantially symmetrical from −180 degrees to +180 degrees relative to the center (0 degrees).

### Effects

The millimeter-wave wireless communication device 100 of the embodiment of this disclosure includes: the feeder circuit layer 110 (first feeder circuit layer) having the substrate 111 (first substrate) that has a first surface and a second surface and is made of glass or ceramic, the metal layer 113 that is provided on the second surface and has the slot 115 (first opening), and the post-wall waveguide 110A (first transmission line) that is configured by a microstrip line, a strip line, a coplanar line, a slot line, or a post-wall waveguide formed in the substrate 111; the antenna layer 130 having the substrate 131 (second substrate) that has a third surface and a fourth surface and is made of resin or glass and the antenna element 132 that is formed on the fourth surface and communicates in the millimeter-wave band; and the adhesive layer 120 (adhesive portion) that adheres the metal layer 113 provided on the second surface of the substrate 111 of the feeder circuit layer 110 and the third surface of the substrate 131 of the antenna layer 130 to each other, wherein the slot 115 and the antenna element 132 are electrically coupled, and power can be fed from the post-wall waveguide 110A through the slot 115 to the antenna element 132. For this reason, the millimeter-wave wireless communication device 100 that can feed power from the slot 115 to the antenna element 132 can be easily fabricated by simply bonding together the feeder circuit layer 110 and the antenna layer 130 with the adhesive layer 120. That is, the millimeter-wave wireless communication device 100 can be fabricated very easily without the need to perform the difficult and unproductive work of bonding together by thermal compression bonding (TCB) a plurality of glass wafers on which copper layers are formed as has conventionally been the case.

Consequently, there can be provided the millimeter-wave wireless communication device 100 that can be easily fabricated. Since the millimeter-wave wireless communication device 100 does not include in its signal transmission line a connection structure using vias or through holes that cause parasitic inductance and parasitic capacitance, it can transmit and receive radio waves in the millimeter-wave band of 30 GHz to 300 GHz with low loss and is particularly suited for transmitting and receiving radio waves in the millimeter-wave band in a high frequency band equal to or higher than 100 GHz.

Furthermore, the relative permittivity of the substrate 131 may be equal to or lower than the relative permittivity of the substrate 111. Satisfying this relationship between the relative permittivities makes it easier to reduce reflection loss and realize transmission of radio waves in the millimeter-wave band with low loss.

Furthermore, when ε1 represents the relative permittivity of the substrate 111, the relative permittivity ε₂ of the substrate 131 may be equal to or higher than √ε₁ and equal to or lower than ε1. Satisfying this relationship between the relative permittivities makes it easier to reduce reflection loss and realize transmission of radio waves in the millimeter-wave band with low loss.

Furthermore, when ε1 represents the relative permittivity of the substrate 111, the relative permittivity ε₃ of the adhesive layer 120 may be equal to or higher than √ε₁ and equal to or lower than ε1. When the relative permittivity of the adhesive layer 120 positioned between the feeder circuit layer 110 and the antenna layer 130 satisfies this relationship, this makes it even easier to reduce reflection loss and realize transmission of radio waves in the millimeter-wave band with low loss.

Furthermore, the relative permittivity ε₃ of the adhesive layer 120 may be higher than the relative permittivity ε₂ of the substrate 131 and lower than the relative permittivity ε₁ of the substrate 111. When the relative permittivities of the feeder circuit layer 110, the adhesive layer 120, and the antenna layer 130 are set in a stepwise manner, this makes it even easier to reduce reflection loss and realize transmission of radio waves in the millimeter-wave band with low loss.

Furthermore, the coefficient of linear expansion of the substrate 131 may be higher than the coefficient of linear expansion of the substrate 111. When an IC chip with a built-in phase shifter and amplifier is mounted on a substrate or the like provided under the feeder circuit layer 110, even when the IC chip gives off heat, the low coefficient of linear expansion of the substrate 111 can inhibit overall warping of the millimeter-wave wireless communication device 100.

Furthermore, the adhesive layer 120 may be an adhesive resin sheet or a prepreg. The feeder circuit layer 110 and the antenna layer 130 can be easily bonded together with the resin sheet or prepreg, and there can be provided the millimeter-wave wireless communication device 100 that can be easily fabricated.

Furthermore, the first opening may be the slot 115 provided in the metal layer 113.

The slot 115 functions like a slot antenna, so power can be fed to the antenna element 132.

The millimeter-wave band may be 30 GHz to 300 GHz. There can be provided the millimeter-wave wireless communication device 100 that can transmit and receive radio waves in the millimeter-wave band of 30 GHz to 300 GHz and can be easily fabricated.

It will be noted that although an aspect where the slot 115 is used as the first opening in the metal layer 113 of the feeder circuit layer 110 was described above, the first opening is not limited to the slot 115.

For example, when a microstrip line, a strip line, a coplanar line, or a slot line is used instead of the post-wall waveguide 110A as the transmission line, cavities such as shown in FIG. 6 may be provided between the metal layers 112 and 113 of the feeder circuit layer 110.

FIG. 6 is a drawing showing an example of the configuration of cavities 110B provided in the feeder circuit layer 110. FIG. 6 shows the arrangement of plural vias 114 provided between the metal layers 112 and 113 and the position of an opening 115A serving as the first opening provided in the metal layer 113.

That is, the feeder circuit layer 110 has the cavities 110B that can transmit radio waves in the millimeter-wave band between the metal layer 113 and the first transmission line (microstrip line, strip line, coplanar line, or slot line).

The plural vias 114, like the plural vias 114 configuring the side walls of the post-wall waveguides 110A, are disposed at intervals so that leakage of millimeter waves does not occur. The cavities 110B have cavity portions 110B1, in which the plural vias 114 are arranged so as to form a circle as viewed in a plan view, and connection portions 110B2, in which part of the circle is interrupted and the vias 114 are arrayed outward as viewed in a plan view. The end portions of the connection portions 110B2 are as an example not provided with vias 114.

Radio waves are introduced into the cavity portions 110B1 via the connection portions 110B2. The connection portions 110B2 are connected to IC chips that include phase shifters and amplifiers. In the cavity portions 110B1, standing waves of radio waves at the operating frequency of the millimeter-wave wireless communication device 100 are generated. In the cavity portions 110B1, radio waves in bands other than the operating frequency do not become standing waves and disappear. The radio waves at the operating frequency become standing waves within the cavity portions 110B1 and propagate through the opening 115A to the antenna element 132. In this way, the antenna element 132 can be fed power using the cavities 110B.

In this way, the millimeter-wave wireless communication device 100 can feed power to the antenna elements 132 even using first openings other than the slots 115.

### First Example Modification

FIG. 7 is a drawing showing an example of the cross-sectional configuration of a millimeter-wave wireless communication device 100M1 of a first example modification of the embodiment. The cross-section shown in FIG. 7 corresponds to the cross-section shown in FIG. 2.

The millimeter-wave wireless communication device 100M1 differs from the millimeter-wave wireless communication device 100 (see FIG. 2) in that it uses an adhesive layer 120M1 configured by a conductive adhesive layer instead of the adhesive layer 120 configured by a resin adhesive layer (see FIG. 2).

As shown in FIG. 7, the adhesive layer 120M1 configured by a conductive adhesive layer has openings 121. The openings 121 are an example of second openings communicated with the slots 115. The openings 121 have as an example the same shape and same size as the slots 115 as viewed in a plan view and are provided with their positions aligned with the slots 115. One opening 121 is provided in correspondence to each slot 115. It will be noted that the openings 121 need only not be inside the slots 115 as viewed in a plan view and may be larger than the slots 115. Furthermore, one opening 121 may be provided relative to a plurality of slots 115.

Examples of the conductive adhesive layer include a conductive bonding sheet, solder, and a conductive paste. The conductive paste is as an example silver paste.

The adhesive layer 120M1 is formed of a conductive material and has second openings communicated with the slots 115. For this reason, the radio waves that the slots 115 radiate in the +Z-direction reach the antenna elements 132 through the openings 121, so the millimeter-wave wireless communication device 100M1 operates in the same way as the millimeter-wave wireless communication device 100 shown in FIG. 2 and achieves the same effects.

Furthermore, since the adhesive layer 120M1 is configured by a conductive adhesive, a shield is provided between the feeder circuit layer 110 and the antenna layer 130, and resistance to external noise and the like can be improved.

### Second Example Modification

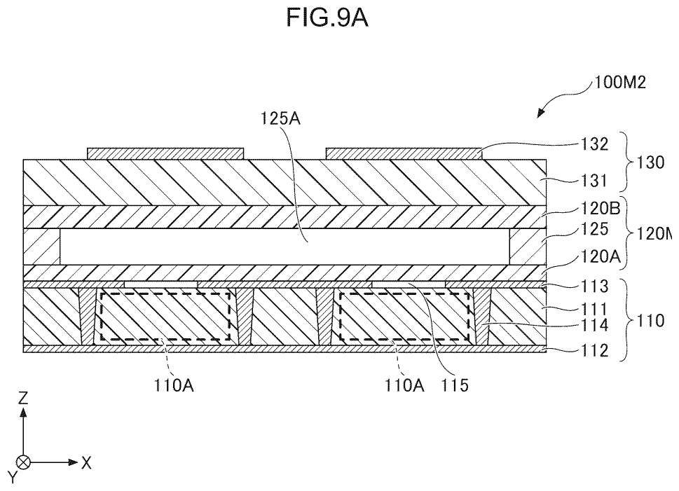

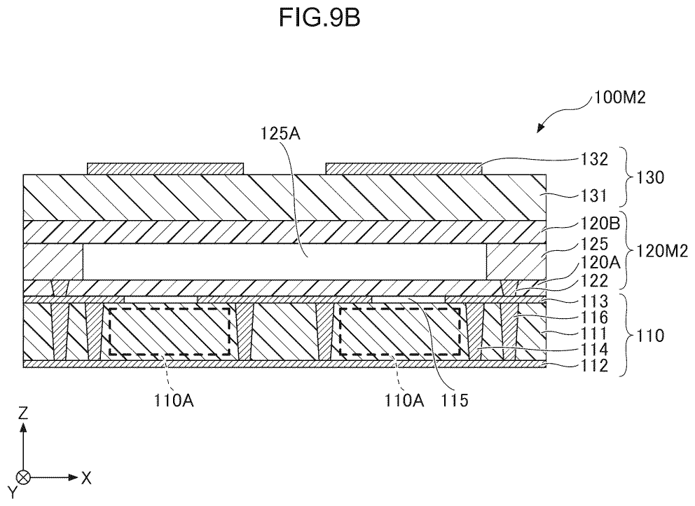

FIG. 8 is a drawing showing an example of a millimeter-wave wireless communication device 100M2 of a second example modification of the embodiment in an exploded state. FIG. 9A is a drawing showing an example of the cross-sectional configuration of the millimeter-wave wireless communication device 100M2 of the second example modification. The cross-section shown in FIG. 9A is a cross-section corresponding to a cross-section viewed from arrows B-B in FIG. 8 in a state in which the millimeter-wave wireless communication device 100M2 of the second example modification is assembled. The cross-section shown in FIG. 9A corresponds to the cross-section shown in FIG. 2.

The millimeter-wave wireless communication device 100M2 differs from the millimeter-wave wireless communication device 100 shown in FIG. 2 in that it includes an adhesive portion 120M2 instead of the adhesive layer 120. Other configurations are the same as those of the millimeter-wave wireless communication device 100M2 shown in FIG. 1 and FIG. 2, so here the configuration of the adhesive portion 120M2 will be described.

### Adhesive Portion 120M2

The adhesive portion 120M2 has two adhesive layers 120A, 120B and a spacer 125. The adhesive layer 120A is an example of a first adhesive layer, and the adhesive layer 120B is an example of a second adhesive layer.

For the two adhesive layers 120A, 120B, as with the adhesive layer 120 shown in FIG. 1 or the adhesive layer 120M1 shown in FIG. 7, resin adhesive layers or conductive adhesive layers can be used. Here, as an example, a configuration where the adhesive layers 120A and 120B are resin adhesive layers will be described.

The resin adhesive layers that can be used as the adhesive layers 120A and 120B are the same as the resin adhesive layer that can be used as the adhesive layer 120 shown in FIG. 1 and FIG. 2, so detailed description will be omitted. The resin adhesive layer used as the adhesive layer 120A and the resin adhesive layer used as the adhesive layer 120B may be different, but it is more preferred that they be the same. It will be noted that the adhesive layers 120A and 120B may be conductive adhesive layers, and their configuration in that case will be described below.

Furthermore, the relative permittivity ε₃ of the adhesive layer 120A is equal to or lower than the relative permittivity ε₁ of the substrate 111. Furthermore, it is preferred that the relative permittivity ε₃ of the adhesive layer 120A be equal to or higher than √ε₁ and equal to or lower than ε₁. ε₁ is the relative permittivity of the substrate 111. Furthermore, it is preferred that the relative permittivity ε₃ of the adhesive layer 120A be higher than the relative permittivity ε₂ of the substrate 131 and lower than the relative permittivity ε₁ of the substrate 111. The same is also true of the relative permittivity of the adhesive layer 120B.

### Spacer 125

The spacer 125 is provided between the adhesive layers 120A and 120B. For this reason, in the second example modification, the spacer 125 is bonded via the adhesive layer 120A onto the feeder circuit layer 110, and the antenna layer 130 is bonded via the adhesive layer 120B onto the spacer 125. For this reason, the distance between the feeder circuit layer 110 and the antenna layer 130 in the Z-direction can be adjusted by using spacers 125 with different thicknesses in the Z-direction.

For the spacer 125, as an example, a spacer fabricated of metal, silicon, resin, or glass can be used. As an example, the spacer 125 is shaped like a frame as viewed in a plan view as shown in FIG. 8 and has a through hole 125A in its center portion. The through hole 125A is an opening that opens in such a way as to not overlap any of the slots 115 and to not overlap any of the antenna elements 132 as viewed in a plan view. This is to ensure that it does not affect the coupling between the slots 115 and the antenna elements 132.

It will be noted that although a configuration where the spacer 125 is shaped like a frame as viewed in a plan view is described here, the spacer 125 may be divided into a plurality along the outer edge of the frame. Furthermore, the through-hole 125A may be divided into a plurality as long as it does not overlap any of the slots 115 and does not overlap any of the antenna elements 132 as viewed in a plan view.

In the millimeter-wave wireless communication device 100M2, the radio waves radiating from the slots 115 pass through the adhesive layer 120A, pass through the through hole 125A in the spacer 125, and pass through the adhesive layer 120B to reach the antenna elements 132. For this reason, the millimeter-wave wireless communication device 100M2 operates in the same way as the millimeter-wave wireless communication device 100 shown in FIG. 2 and achieves the same effects.

Furthermore, the spacer 125 is configured by metal, silicon, resin, or glass, so it can be easily fabricated. In the second example modification, there can be provided the millimeter-wave wireless communication device 100M2 that can be easily fabricated and includes the spacer 125 that can be easily fabricated.

Furthermore, when the spacer 125 is made of metal, a shield is provided between the feeder circuit layer 110 and the antenna layer 130, and resistance to external noise and the like can be improved.

It will be noted that the millimeter-wave wireless communication device 100M2 of the second example modification may have a configuration such as shown in FIG. 9B. FIG. 9B is a drawing showing an example of the cross-sectional configuration of the millimeter-wave wireless communication device 100M2 of another aspect of the second example modification.

In the millimeter-wave wireless communication device 100M2 shown in FIG. 9B, the feeder circuit layer 110 has vias 116 that penetrate the substrate 111, and the adhesive portion 120M2 has vias 122 that penetrate the adhesive layer 120A. Furthermore, in the millimeter-wave wireless communication device 100M2 shown in FIG. 9B, the spacer 125 is made of metal.

The vias 116 penetrate the substrate 111 in the same way as the vias 114 and have lower ends connected to the metal layer 112 and upper ends connected to the metal layer 113. The vias 116 may be vias not used as side walls of the post-wall waveguides 110A or may be vias used as side walls of the post-wall waveguides 110A. The vias 116 can be fabricated in the same way as the vias 114.

The vias 122 penetrate the adhesive layer 120A and are provided in the same positions as the vias 116 as viewed in a plan view as an example. The vias 122 have lower ends connected to the metal layer 113 and upper ends connected to the lower surface of the spacer 125. The via 122, like the vias 114 and 116 of the feeder circuit layer 110, can be formed of copper or aluminum as an example.

In the millimeter-wave wireless communication device 100M2 shown in FIG. 9B, the spacer 125 is connected via the vias 122 to the metal layer 113, so the potential of the spacer 125 can be set to ground potential. For this reason, by providing a shield configured by the spacer 125 at ground potential between the feeder circuit layer 110 and the antenna layer 130, resistance to external noise and the like can be improved.

### Third Example Modification

FIG. 10 is a drawing showing an example of the cross-sectional configuration of a millimeter-wave wireless communication device 100M3 of a third example modification of the embodiment. The cross-section shown in FIG. 10 corresponds to the cross-section shown in FIG. 2.

The millimeter-wave wireless communication device 100M3 has a configuration where a feeder circuit layer 140A is further provided under the metal layer 112 of the millimeter-wave wireless communication device 100 shown in FIG. 2. The feeder circuit layer 140A is an example of a second feeder circuit layer.

In the millimeter-wave wireless communication device 100M3, the antenna layer 130 has vias 133 and terminals 134 in addition to the substrate 131 and the antenna elements 132. Lower ends of the vias 133 extend downward from the lower surface of the substrate 131, penetrate the adhesive layer 120, and are connected to the upper surface of the metal layer 113. Upper ends of the vias 133 extend to the upper surface of the substrate 131 and are connected to the terminals 134 provided on the upper surface of the substrate 131. The terminals 134 are provided near the antenna elements 132.

The layer in which the antenna elements 132 and the terminals 134 are positioned is an L1 layer. The layer in which the metal layer 113 is positioned is an L2 layer. The layer in which the metal layer 112 is positioned is an L3 layer.

The feeder circuit layer 140A is provided under the feeder circuit layer 110 and as an example is configured by a multilayer substrate having wiring layers or ground layers of an L4 layer, an L5 layer, and an L6 layer, an insulating layer on the L4 layer, and insulating layers provided between the wiring layers or ground layers of the L4 layer, the L5 layer, and the L6 layer. The feeder circuit layer 140A is positioned lower than the L3 layer of the feeder circuit layer 110. The feeder circuit layer 140A is as an example a build-up substrate.

The wiring of the L4 layer of the feeder circuit layer 140A and the metal layer 113 that is the L3 layer are electrically coupled via slots or the like as an example. Furthermore, the wiring of the L4 layer of the feeder circuit layer 140A and the metal layer 113 that is the L3 layer may be connected via wiring or the like not shown in the drawings.

A feeder circuit layer 140B is connected via a connection portion 150 to the wiring of the L6 layer of the feeder circuit layer 140A. The feeder circuit layer 140B is as an example a build-up substrate like the feeder circuit layer 140A. The connection portion 150 is as an example wiring capable of interconnecting the wiring of the feeder circuit layers 140A and 140B and is as an example a flexible printed circuit (FPC).

IC chips 160 are mounted to the lower surfaces of the feeder circuit layers 140A and 140B. The IC chips 160 each have as an example a built-in phase shifter, which adjusts the phase of the transmission signals supplied to the plural antenna elements 132 serving as a phased array antenna, and amplifier, which amplifies the transmission signals. It will be noted that the phase shifter also similarly adjusts the phase of the received signals. Furthermore, the IC chips 160 also each have a built-in amplifier that amplifies the received signals.

The feeder circuit layer 110 and the antenna layer 130 bonded together by the adhesive layer 120 can transmit and receive radio waves in the millimeter-wave band. The millimeter-wave wireless communication device 100M3, as a result of the IC chips 160 being disposed directly under the feeder circuit layer 110 and the antenna layer 130, realizes a configuration that can reduce signal transmission loss between the IC chips 160 and the feeder circuit layer 110 and transmit signals in the millimeter-wave band.

Exemplary millimeter-wave wireless communication devices of this disclosure have been described above, but this disclosure is not limited to the specifically disclosed embodiment, and various modifications and changes may be made without departing from the scope of the claims.

What is claimed is:

1. A millimeter-wave wireless communication device comprising:
a first feeder circuit layer having a first substrate that has a first surface and a second surface and is made of glass or ceramic, a metal layer that is provided on the second surface and has a first opening, and a first transmission line that is configured by a microstrip line, a strip line, a coplanar line, a slot line, or a post-wall waveguide formed in the first substrate;
an antenna layer having a second substrate that has a third surface and a fourth surface and is made of resin or glass and an antenna element that is formed on the fourth surface and communicates in the millimeter-wave band; and
an adhesive portion that adheres the metal layer provided on the second surface of the first substrate of the first feeder circuit layer and the third surface of the second substrate of the antenna layer to each other, wherein the first opening and the antenna element are electrically coupled, and power can be fed from the first transmission line through the first opening to the antenna element.

2. The millimeter-wave wireless communication device of claim 1, wherein the relative permittivity of the second substate is equal to or lower than the relative permittivity of the first substrate.

3. The millimeter-wave wireless communication device of claim 2, wherein when ε₁ represents the relative permittivity of the first substrate, the relative permittivity ε₂ of the second substrate is equal to or higher than √ε₁ and equal to or lower than ε₁.

4. The millimeter-wave wireless communication device of claim 2, wherein when ε₁ represents the relative permittivity of the first substrate, the relative permittivity ε₃ of the adhesive portion is equal to or higher than √ε₁ and equal to or lower than ε₁.

5. The millimeter-wave wireless communication device of claim 4, wherein the relative permittivity ε₃ of the adhesive portion is higher than the relative permittivity ε₂ of the second substrate and lower than the relative permittivity ε₁ of the first substrate.

6. The millimeter-wave wireless communication device of claim 1, wherein the coefficient of linear expansion of the second substrate is higher than the coefficient of linear expansion of the first substrate.

7. The millimeter-wave wireless communication device of claim 1, further comprising a second feeder circuit layer having a dielectric layer that is provided on the first surface side of the first substrate and a second transmission line that is provided in the dielectric layer and is connected to the first transmission line or electrically coupled to the first transmission line.

8. The millimeter-wave wireless communication device of claim 1, wherein the adhesive portion has a second opening communicated with the first opening and is formed of a conductive material.

9. The millimeter-wave wireless communication device of claim 1, wherein the adhesive portion is an adhesive resin sheet or a prepreg.

10. The millimeter-wave wireless communication device of claim 1, wherein the adhesive portion has
a first adhesive layer that is adhered to the metal layer provided on the second surface,
a second adhesive layer that is adhered to the third surface, and
a spacer that is adhered between the first adhesive layer and the second adhesive layer.

11. The millimeter-wave wireless communication device of claim 10, wherein the spacer is configured by metal, silicon, resin, or glass.

12. The millimeter-wave wireless communication device of claim 1, wherein the first opening is a slot provided in the metal layer.

13. The millimeter-wave wireless communication device of claim 1, wherein
the first feeder circuit layer has a cavity that can transmit radio waves in the millimeter-wave band between the metal layer and the first transmission line, and
the first opening is an opening provided above the cavity.

14. The millimeter-wave wireless communication device of claim 1, wherein the millimeter-wave band is 30 GHz to 300 GHz.
